(19) United States
(12) Patent Application Publication
(10) Pub. No.: US 2005/0107099 A1
(43) Pub. Date: May 19, 2005

(54) Method and device for transmitting information

(76) Inventors: Petra Schutze, Berlin (DE); Christof Florek, Berlin (DE); Nils Scharmberg, Berlin (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/481,618

(22) PCT Filed: Jun. 21, 2002
(86) PCT No.: PCT/EP02/06932

(30) Foreign Application Priority Data
Jun. 21, 2001 (DE) 101 30 312.2
Jul. 20, 2001 (DE) 101 35 429.0

(51) Int. Cl. H04Q 7/20

(52) U.S. Cl. 455/466; 715/535; 715/700; 345/156; 340/691.1

(57) ABSTRACT

The invention relates to a method and a device for transmitting information from a transmitter to a receiver. According to the invention, a symbol (image) is selected on the transmitter side; a character string assigned to the symbol is determined on the transmitter side; the character string assigned to the symbol is transmitted to the receiver, the character string is converted into the corresponding symbol on the receiver side; the symbol is shown on a display device and at least one sound sequence assigned to the symbol is acoustically reproduced at the same time.

The invention relates to a method and a device for transmitting information from a transmitter to a receiver.

Methods and devices of this type are known in the art and are used, for example, with modern mobile telephones. With these mobile telephones, for example, the user of the transmitting mobile telephone selects certain symbols when sending a SMS message. In conventional applications, these are typically standard symbols “+’, “−”, “.”, “,”, “:”, “;”, “″”, “?”, “!”, “*”, “/”, “(“,”)”, “<”, “=”, “>”, “%”, “&”, “P”, “$”, “@”. These symbol are then transmitted as a symbol.

In addition to voice transmission, the transmission of so-called SMS (short message service) messages is known in the art. Reference is made here, for example, to Connect 8/99, page 30 ff. Accordingly, mobile telephones (transmitters) can send short messages to another mobile telephone (receiver). Voice messages can also be sent by way of such short messages.

Conventional mobile telephones as well as conventional methods and devices capable of transmitting information from one mobile telephone to another mobile telephone, transmit the information, for example a symbol or an audio sequence, in its original form.

With this approach, for example when transmitting audio information using electromagnetic transmission, i.e., using a transmission method relying on electromagnetic waves, as is customary with mobile telephones, the audio signals are transmitted in their original form, i.e., sent by modulating the transmission frequency. Accordingly, in conventional applications a large amount of data has to be transmitted when sending audio signals. For example, in a digital transmission each individual audio signal has to be converted to a sequence of bits and these bits have to be subsequently transmitted. The large amount of data necessary requires a certain transmission time which can prolong or delay the transmission.

This requires a large amount of data for transmitting the information. Accordingly, a significant amount of time is also required to transmit the information.

There is a need for users of a mobile telephone to be able to also transmit other information without significantly increasing the telephone bill and/or without increasing the required transmission time.

It is therefore an object of the present invention to improve a method and a device of the aforedescribed type so as to overcome the afore-mentioned disadvantages, to transmit information in a shorter time interval and to enable an enhanced information transmission.

The object is solved by a method with the features recited in claim 1 in that on the transmitter side a symbol (image) is selected, that on the transmitter side a character string associated with the symbol is determined, that the character string associated with the symbol is transmitted to the receiver, and that on the receiver side the character string is converted to the associated symbol, that the symbol is displayed on a display device and that simultaneously at least one audio sequence associated with the symbol is acoustically reproduced.

This approach according to the method advantageously requires only the character string to be transmitted from the transmitter to the receiver. For example, if the user of a device that uses this method selects for transmission the symbol Sun with an associated audio sequence, then only the word “Sun” has to be transmitted, and no longer the actual symbol and the actual audio sequence. The transmission of the word “Sun” requires significantly less transmission time, so that the transmission is faster and less expensive. The character string is again converted on the receiver side to the associated symbol, so that the recipient of the information can then view a symbol of the sun on the display or the like.

Advantageously, through association of the audio sequence which is acoustically reproduced at the same time, a musical background can be initiated by the transmitter side in addition to displaying the images on the receiver side. In this way, the recipient can be additionally alerted to the transmitted symbol, since the musical background can be heard even if the recipient cannot see the image. In addition, the recipient of the symbol can advantageously experience additional emotions, memories, thoughts or the like that are triggered by the musical background.

According to an advantageous embodiment, on the transmitter side, the symbol can be selected from a table of symbols. This can, for example, be accomplished by using a display. For example, the user of a mobile telephone can select on the display a particular symbol which (s)he wishes to transmit from a series of symbols or a table of symbols. The mobile telephone converts internally the selected symbol to the corresponding word or the corresponding character string which is then transmitted. The table of symbols significantly simplifies the selection of symbols for the user. Preferably, the symbols or the table of symbols are previously stored in a memory.

According to another preferred embodiment, the selection of the symbols and/or of the association of the character string with his selected symbol and/or the transmission or reception of the character string are controlled by a microprocessor. Preferably, the method can be used with a device which includes the memory for storing the table of symbols and associated character strings, the microprocessor and the input unit or the keypad, all of which can be integrated on a printed circuit board. Accordingly, the entire method can be used in modern mobile telephones, since no additional features are required that could not be integrated in conventional mobile telephones. The entire method of the invention and the entire device of the invention for transmitting symbols from a transmitter to a receiver can therefore be used with conventional mobile telephones.

In addition, in a preferred method, an identification character can be appended to the character string when the character string is transmitted from the transmitter. By using this identification character, a character string can be distinguished from other character strings that do not represent a symbol. For example when sending the above-mentioned symbol Sun, the symbol Sun is initially converted to the word “Sun” and subsequently provided with an identification character, for example with the identification character “#”. The character string having the identification character “#” is then sent by the transmitter unit of the transmitter. On the receiver side, the identification character associated with character string makes it possible to distinguish between ordinary character strings and those character strings that code a symbol. In a preferred embodiment, the receiver side can recognize whether or not a character string has the identification character which identifies the character string as a coded symbol. If the character string does not include an identification character which identifies the character string as a coded symbol, then the character string is processed on the receiver side in a normal fashion, for example displayed to the user of the receiving mobile telephone. Conversely, if the character string is an identified character string, then the receiver unit recognizes that it is a coded symbol and preferably searches a table stored in a memory for the corresponding associated symbol and the associated audio sequence. When the symbol and the audio sequence have been found on the receiver side, the symbol can be displayed and the associated audio sequence can be played. The user on the receiver side therefore is not aware that only the character string was transmitted, but instead sees directly the symbol and hears the audio sequence and is therefore under the impression that the symbol and the audio sequence were actually transmitted.

The method can also be implemented on the receiver side by employing a microprocessor, which controls fetching from the memory the tables of symbols and audio sequences and associated character strings and which also controls the receiving unit of the receiver and optionally also the display unit for displaying the finally determined symbol and the reproduction unit that plays the audio sequence.

In a particularly advantageous embodiment, a microprocessor processes an algorithm stored in a memory when converting a symbol to a character string. Accordingly, no table is required in this embodiment. This association of a character string by using a symbol and an audio sequence can be implemented on the receiver side with an algorithm when associating a symbol and/or an audio sequence with a character string. In another embodiment of the invention, coding according to the invention is performed only on one side. In other words, in this embodiment, the method codes or reproduces in coded form the symbol and/or the audio sequence only on one side, i.e. either at the receiver or at the transmitter. In this embodiment the user enters for transmission, for example, only the character string. Preferably, the user can add an identification character to the character string. The identified character string is then sent by the transmitter to the receiver. In this case, only the receiver is capable of converting the identified character string to the corresponding symbol and the corresponding audio sequence. This situation can occur, for example, if only the receiving mobile telephone includes the corresponding display/reproduction devices that allow display of a symbol and/or reproduction of the audio sequence, whereas the transmitting mobile telephone does not enable display of symbols or audio reproduction.

Conversely, the symbol can be converted to a character string on the transmitter side, which is not possible on the receiver side. In this situation, the selected symbol is converted to a character string only on the transmitter side, whereas only the character string is displayed on the receiver side. In the aforementioned example, the user of the transmitting mobile telephone selects the symbol Sun. Thereafter, according to the method of the invention, the symbol Sun is converted to the character string “sun” by using the association table, and this character string is subsequently transmitted. On the receiver side, the character string itself is displayed, because the receiver is not capable of displaying the symbol Sun.

According to another embodiment of the invention, the method of the invention and/or the device of the invention recognizes before the selected symbol is coded the language to be used for coding the selected symbol. The language can optionally also be preset by the user. For example, a German-speaking user or a user who has selected the German language as the default transmission language transmits the symbol sun as the word “Sonne”. Conversely, an English-speaking user or a user who has selected the English language as the default transmission language, transmits the symbol sun as the character string “Sun”. In another embodiment, all major world languages are programmed into memory. The transmitting telephone is then transmits using the default language set in the transmitting telephone, whereas the receiving telephone uses the microprocessor to search in the different tables stored in memory for the particular language in which the message was received and then displays the symbol selected by the sender.

In another embodiment, the transmitter can be a telephone and the receiver can be a personal computer (PC) or a fax machine. The transmitted symbol can then displayed by the PC or printed by the fax.

Additional advantageous embodiments of the invention are recited in the other dependent claims.

The invention will be described in more detail hereinafter with reference to embodiments to be read in conjunction with the appended drawings. It is shown in:

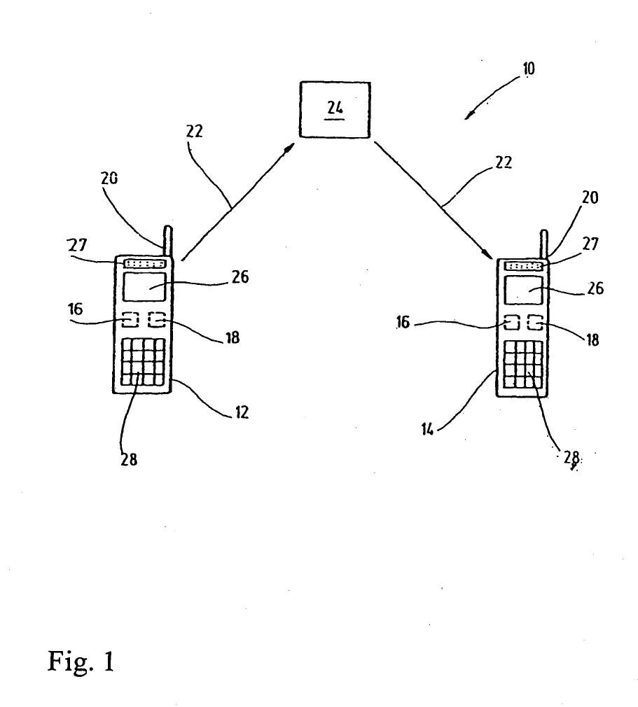

FIG. 1 schematically, an arrangement of a transmitter and a receiver for transmitting of individual symbols (individual images);

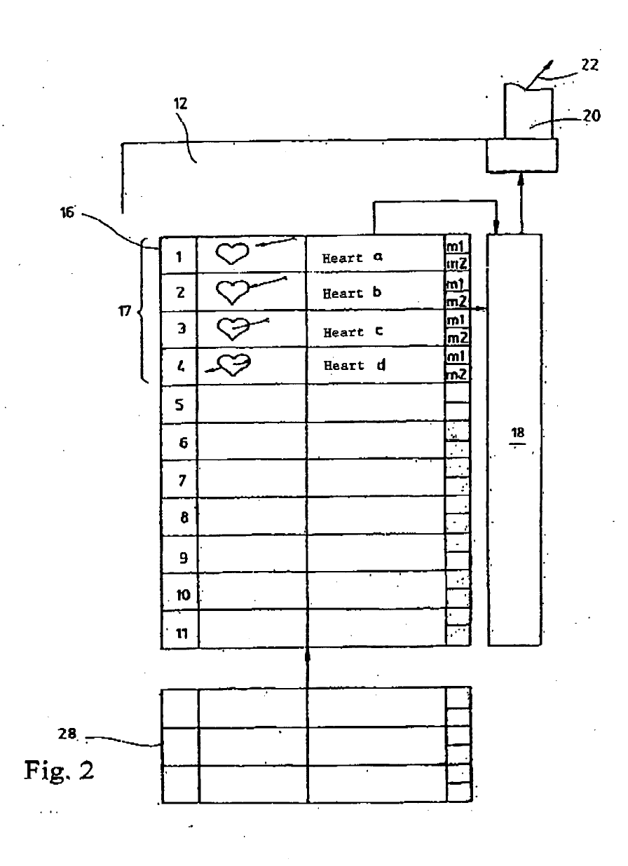

FIG. 2 a block diagram for transmitting individual symbols with musical background;

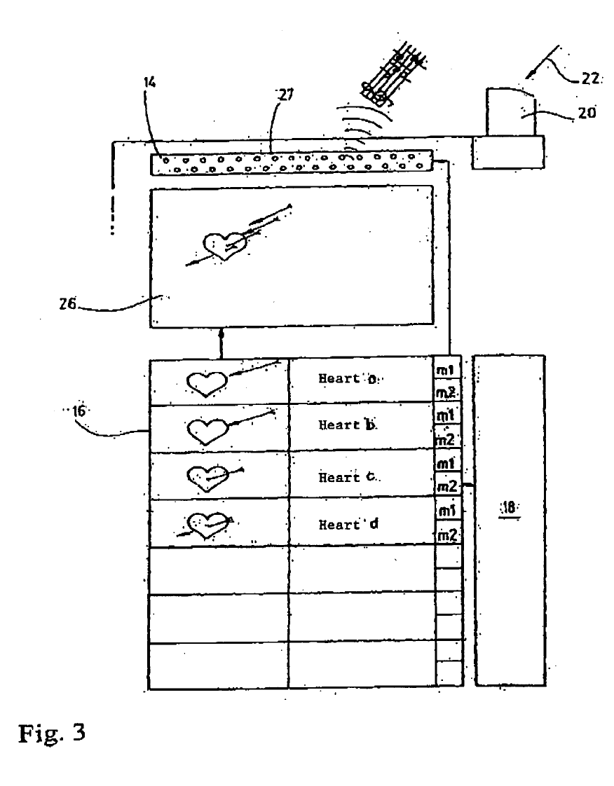

FIG. 3 a block diagram for receiving individual symbols with musical background; and

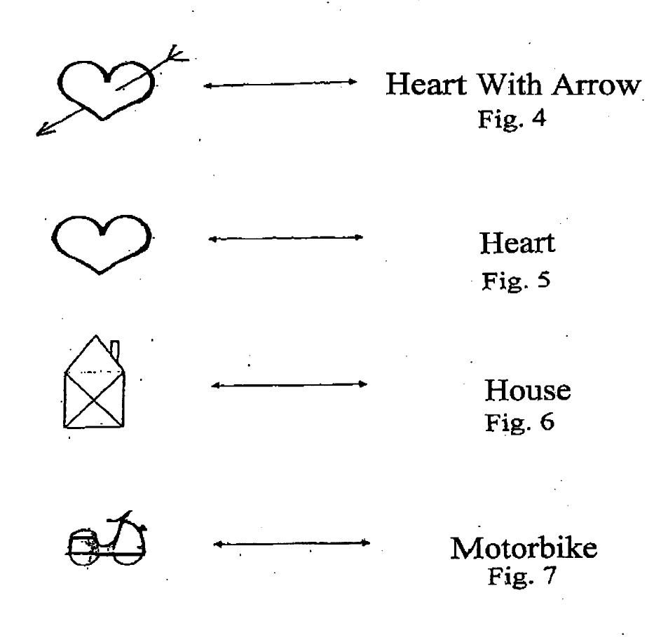

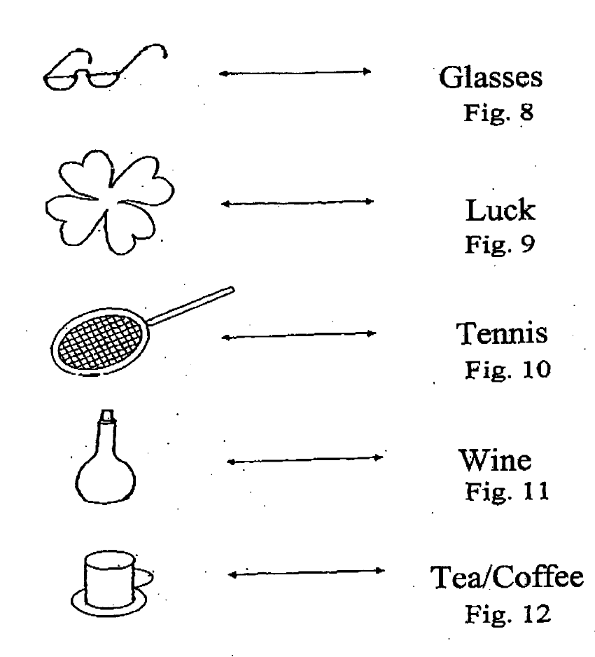

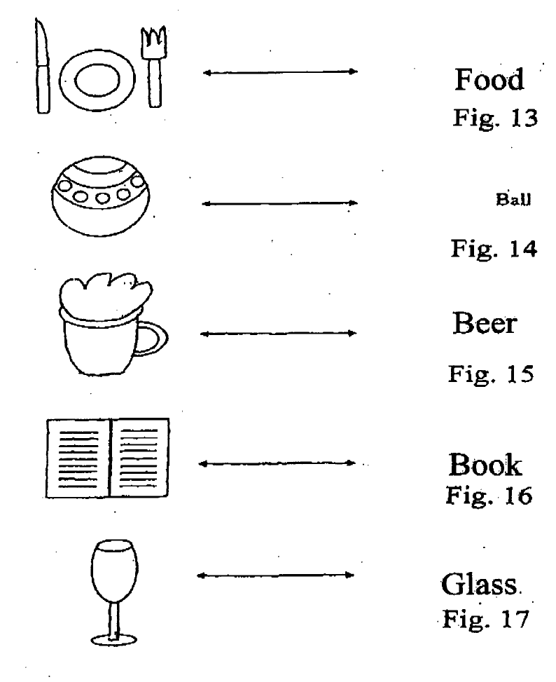

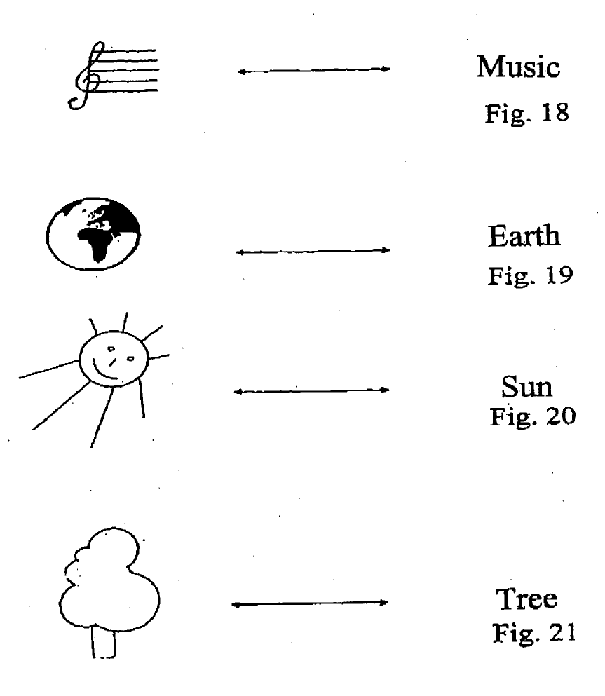

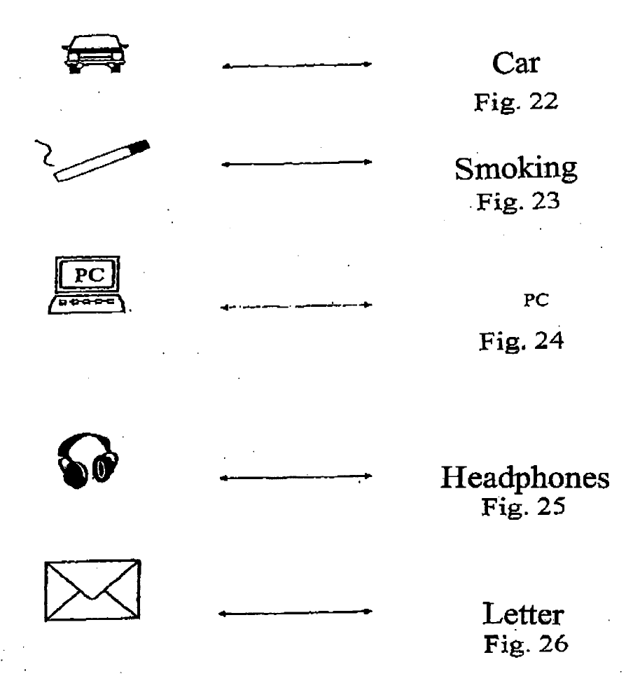

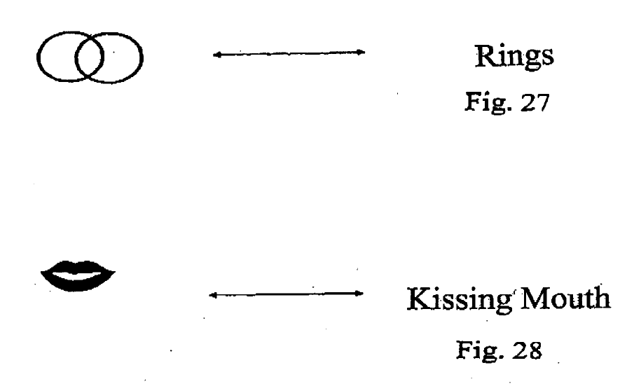

FIGS. 4 to 28 schematically, other possible symbols that can be transmitted by using the method.

FIG. 1 shows schematically an arrangement 10 for transmitting individual symbols (individual images) with musical background from a transmitter 12 to a receiver 14. Transmitter 12 and/or receiver 14 can be, for example, mobile telephones, PCs, fax machines, communicators, laptops, notebooks and the like. Other exemplary devices are suitably equipped terminals (telephones) connected to telecommunication systems. In the following exemplary embodiment, the transmitter 12 and the receiver 14 can each be a mobile telephone, with the functions being easily applicable also to other devices. These functions therefore explicitly form part of the present invention.

It will be assumed that an operator of the transmitter 12 intends to send a symbol (image) with a musical background to a person having in his/her possession the receiver 14. The operator of the transmitter 12 fetches—in a manner to be described in more detail below—from a memory means 16 an image (subsequently also referred to as symbol). Optionally and in addition, information can be called up that initiates at the receiver, in addition to the display of the image, a reproduction of at least one audio sequence.

On the transmitter side, the symbol and optionally the initialization information of the audio sequence to be reproduced are processed by a microprocessor 18 and transmitted to a service provider 24 via a transmission/receiving device 20 in form of a short message 22. Service providers 24 are, for example, operators of mobile telephone systems, such as C-, D- and E-networks and the like. The transmission of a short message 22 via a service provider 24 to a selected receiver 14 is generally known and will therefore not be described in detail.

The symbol (image) and optionally the short message 22 which represents the initialization information that reproduces the audio sequence, is transmitted by way of the service provider 24. The receiver 14 recognizes—in a manner that will also be described later—that the short message 22 represents a symbol (image) with musical background. When the short message 22 is fetched by the receiver 14, which need not occur immediately, but can also occur at a later time, the corresponding image is displayed on a display device 26, because a microprocessor 18, which cooperates with a memory means 16, causes the receiver 14 to recognize the symbol (image). The audio sequence associated with the image is also reproduced by a loudspeaker 27 as a melody, optionally with a vocal part.

FIG. 2 is a schematic block diagram of the transmission of individual symbols with musical background. Elements identical to those of FIG. 1 are provided with the same reference characters and will not be described again. The built-in options for transmitting symbols with musical background can be displayed on the display device 26 by using an operating unit 28, implemented for example as an alphanumeric keypad. The display can be menu-driven, for example, by displaying individually, sequentially or concurrently the existing options through activation of corresponding keys on the operating unit 28. In the described exemplary embodiment, the symbol to be transmitted is represented by a heart with an approaching arrow. This image is stored, for example, in the memory means 16 under the ordinal number “1”. A character string is associated with each symbol that corresponds to an image symbol. This association is stored in the memory means 16, for example in form of the schematically depicted table. For example, the character string “Hearta” is associated with the image “1”.

Also associated in the memory means 16 are the audio sequences (music) which serves as musical background for the symbols. For example, a selection of two possible audio sequences “m1” and “m2”, respectively, can be associated with each symbol (image). Each of these abbreviations “m1” and “m2”, respectively, initiates at the receiver a reproduction of a certain associated audio sequence when the image is transmitted—as will be explained in detail below. In the illustrated example, the audio sequence “m1” or “m2” can be selected. In additional embodiments, only a single audio sequence “m” or several audio sequences “m1” to “mx” can be associated with each image.

If the transmitter 12 is to transmit to a receiver 14 the heart with the approaching arrow as an image with a musical background, then the microprocessor 18 controls the transmitter and receiver unit 20 such that the character string “Heartam1” is sent as a short message.

On the receiver side, the short message is transmitted from the existing transmitter and receiver unit 20 to the microprocessor 18 which reads the associated image symbol and the associated audio sequence from the memory means 16. By controlling the display device 26 and the loudspeaker 27 at the receiver 14, the image “1” can be displayed and the audio sequence (music) corresponding to the character string “m1” can be played at the same time. The person viewing the receiver-side display device 20 sees the heart with the approaching arrow as a stationary image and simultaneously hears the associated melody. The melody can also consist of any audio sequence that has been predefined and is stored in the memory means 16 of the receiver. Audio sequences can include, for example, simple successive sounds, complex melodies and/or melodies with singing. In a concrete example, the melody “Wedding March” could be played when the heart with the approaching arrow is displayed.

The short message 22 for the receiver can be identified as a transmission of a symbol (image) with an associated audio sequence by employing an additional identification character, for example the key “#”, in which case the short message would be represented by the character string “Heartam1#”.

FIG. 3 shows once more schematically reception of the short message 22 at the receiver 14. The microprocessor 18 receives the short message 22 via the transmission and receiver unit 20 and transmits the short message 22 to the memory unit 16. Since the characters are uniquely associated with the symbols, and since the character string “m” is uniquely associated with the audio sequences, the individual symbol (image) can be displayed on the display device 26 based on the received short message 22 and likewise, the associated audio sequence can be reproduced by the loudspeaker 27 at the same time.

The microprocessor circuit 18 can execute a loop, whereby the information transmitted as a short message 22 and converted by the memory unit 16 into image sequences and/or audio sequences can be continuously repeated and/or reproduced. This process can continue until an operator at the receiver 14 interrupts or stops the image display and/or the audio reproduction.

The short message 22 can be fetched on the receiver side and the images can be displayed and the audio sequences reproduced either immediately after the short message 22 has been received or at a later time. In the latter case, the message is temporarily stored until it is fetched by the operator of the receiver 14.

FIGS. 4 to 28 show additional examples of symbols that can be transmitted by using the method of the invention. The symbols (images) that can be selected and transmitted are illustrated on the left side of the Figures, whereas the corresponding associated characters are shown on the right side of the Figures. The ordinal numbers referred to in FIGS. 2 and 3 by the ordinal numbers “1”, “2”, “3” . . . “x” correspond to, for example, a respective symbol illustrated in the Figures and having the associated character string (which may also be—as shown—a readable word). Before being transmitted, the respective symbol is converted into the corresponding character string and the desired audio sequence “m” is selected.

The illustrated embodiments are not intended to be exhaustive. It will be understood that any symbol can be combined with any audio sequence. In addition, various modifications, as described in the specification, are feasible for converting the symbols to the character strings and vice versa, optionally with translation into another user-defined language.

| German | English |
|---|---|
| Herz | Heart |
| Herz mit Pfeil | Heart with arrow |
| Haus | House |
| Mofa | Scooter |
| Brille | Glasses (spectacles) |
| Glück | Luck |
| Tennis | Tennis |
| Wein | Wine |
| Tee/Kaffee | Tea/Coffee |
| Essen | Eating/Dining |
| Ball | Ball |
| Bier | Beer |
| Buch | Book |
| Glas | Glass |
| Musik | Music |
| Erde | Earth |
| Sonne | Sun |
| Baum | Tree |
| Auto | Automobile |
| Rauchen | Smoking |
| PC | PC |
| Kopfhörer | Headphone |
| Brief | Letter |
| Ringe | Rings |
| Kussmund | Mouth (literally: kissing mouth) |

1. Method for transmitting information from a transmitter to at least one receiver, characterized in that on the transmitter side a symbol (image) is selected, that on the transmitter side a character string associated with the symbol is determined, that the character string associated with the symbol is transmitted to the receiver, and that on the receiver side the character string is converted to the associated symbol, that the symbol is displayed on a display device and that simultaneously at least one audio sequence associated with the symbol is acoustically reproduced.

2. Method according to claim 1, characterized in that on the transmitter side the symbol is selected from a table of symbols.

3. Method according to one of the preceding claims claim 1, characterized in that on the transmitter side the symbol is fetched from a memory, in which memory the symbol was stored before being fetched.

4. Method according to claims 2 and 3, characterized in that on the transmitter side the table of symbols was previously stored in the memory.

5. Method according to claim 1, characterized in that on the transmitter side the symbol is selected using a microprocessor which is controlled by an input unit.

6. Method according to claim 1, characterized in that on the transmitter side the character string associated with the symbol is determined using a microprocessor.

7. Method according to claim 6, characterized in that on the transmitter side the character string is determined by the microprocessor using an algorithm that was previously stored in a memory.

8. Method according to claim 1, characterized in that on the transmitter side the character string is determined by using a table of symbols and associated character strings.

9. Method according to claim 6, characterized in that the table is fetched from memory by the microprocessor.

10. Method according to claim 1, characterized in that the character string associated with the symbol is a character string that corresponds to and/or identifies the symbol.

11. Method according to claim 1, characterized in that on the transmitter side an identification character is added before the character string is sent, which identification character designates the character string as a coded symbol, wherein the identification character is transmitted together with the character string.

12. Method according to claim 1, characterized in that on the receiver side the symbol associated with the received character string and the associated audio sequences is determined based on a table of character strings and associated symbols and audio sequences.

13. Method according to claim 1, characterized in that on the receiver side the symbol associated with the received character string and the audio sequence is fetched from a memory, in which memory they were stored together with the character string before being fetched.

14. Method according to claim 12, characterized in that on the receiver side the table that contains the character strings and associated symbols and audio sequences was previously stored in the memory.

15. Method according to claim 1, characterized in that on the receiver side the symbol associated with the received character string and the associated audio sequence are automatically determined by a microprocessor.

16. Method according to claim 15, characterized in that on the receiver side the symbol associated with the received character string and the audio sequence are determined by the microprocessor by using an algorithm previously stored in a memory.

17. Method according to claims 15, characterized in that on the receiver side an associated symbol and associated audio sequence are determined only for those received character strings that include an identification character, which identification character identifies the character string as a coded signal.

18. Method according to claim 1, characterized in that on the receiver side the determined symbol is displayed on a display.

19. Method according to claim 1, characterized in that on the receiver side the at least one audio sequence associated with the symbol is fixedly associated therewith.

20. Method according to claim 1, characterized in that the audio sequence reproduced on the receiver side can be affected from the transmitter side.

21. Method according to claim 1, characterized in that several audio sequences are stored on the receiver side, wherein at least one of the audio sequences can be called up from the transmitter side.

22. Device for transmitting information from a transmitter to at least one receiver, characterized in that a microprocessor, which cooperates with at least one memory means, is associated with the transmitter and the at least one receiver, and that a plurality of symbols (images) together with their respective associated character strings as well as at least one audio sequence associated with a symbol are stored in the at least one memory means, and with a display device for displaying the symbols and with an acoustic reproduction unit for reproducing the at least one audio sequence and with a transmitter and receiver device for transmitting the character strings.

23. Mobile telephone, characterized by a device according to claim 22.
